(19) United States
(12) Patent Application Publication
(10) Pub. No.: US 2023/0095859 A1
(43) Pub. Date: Mar. 30, 2023

(54) ROTATION DEVICE

(71) Applicant: FANUC CORPORATION, Yamanashi (JP)

(72) Inventor: Masahiro MUROTA, Yamanashi-ken (JP)

(21) Appl. No.: 17/793,671

(22) PCT Filed: Jan. 18, 2021
(86) PCT No.: PCT/JP2021/001438

§ 371 Date: Jul. 19, 2022

(30) Foreign Application Priority Data
Jan. 24, 2020 (JP) 2020-009575

(51) Int. Cl. F16F 15/34; F16B 41/00; F16F 15/32

(52) U.S. Cl. CPC F16F 15/34; F16B 41/002; F16F 15/322; B23Q 1/706

(57) ABSTRACT

A rotation device capable of improving safety includes a plurality of screw holes that each extend along the radial direction of a rotation member and each has an opening on a surface of the rotation member; and a stopper for preventing a screw disposed inside the screw hole from protruding to the outside of the opening, without interfering with insertion of a tool, for turning the screw, into the screw hole.

### TECHNICAL FIELD

The present invention relates to a rotation device equipped with a rotating body that rotates in conjunction with a rotatable shaft and whose balance can be adjusted using a screw.

### BACKGROUND ART

JP H10-238594 A discloses a balance adjusting device for a rotating body. In this balance adjusting device, a rotating body (rotating member) that rotates in conjunction with a rotatable shaft is provided with a plurality of screw holes radially extending from the center of the rotating body. A balance adjusting screw is disposed inside each screw hole in a manner of being screw-engaged into the screw hole.

### SUMMARY OF THE INVENTION

However, there is a concern that expansion or the like of the screw hole due to temperature change may occur, and as a result, loosening of the screw engaged with the screw hole may occur, so that the screw may fly out from the screw hole to the outside during rotation of the rotating body.

Accordingly, an object of the present invention is to provide a rotation device which is capable of improving safety.

According to an aspect of the present invention, there is provided a rotation device equipped with a rotating body that rotates in conjunction with a rotatable shaft and whose balance is adjustable using a screw, comprising: a plurality of screw holes extending in a radial direction of the rotating body and having an opening that is open on a surface of the rotating body; and a stopper portion configured to prevent the screw disposed inside the screw hole from coming out of the opening to outside without hampering insertion of a tool configured to turn the screw, into the screw hole.

According to the present invention, even when loosening of the screw screwed into the screw hole occurs due to expansion or the like of the screw hole caused by a temperature change, the screw is prevented from flying out of the screw hole to the outside during rotation of the rotating body. As a result, safety can be improved.

### BRIEF DESCRIPTION OF DRAWINGS

FIG. 1 is a schematic view showing a rotation device of the present embodiment;

FIG. 2 is a schematic view showing a state in which a tool is fitted into a screw;

FIG. 3 is a schematic diagram illustrating a rotating body provided with a stopper portion, according to a first modification;

FIG. 4 is a schematic view showing the stopper portion of the first modification from the same viewpoint as FIG. 2;

FIG. 5 is a schematic view showing a stopper portion according to a second modification from the same viewpoint as FIG. 2;

FIG. 6 is a schematic view showing a stopper portion of a third modification from the same viewpoint as FIG. 2; and

FIG. 7 is a schematic view showing a stopper portion of a fourth modification from the same viewpoint as FIG. 2.

### DESCRIPTION OF THE INVENTION

A preferred embodiment of the present invention will be described below in detail with reference to the accompanying drawings.

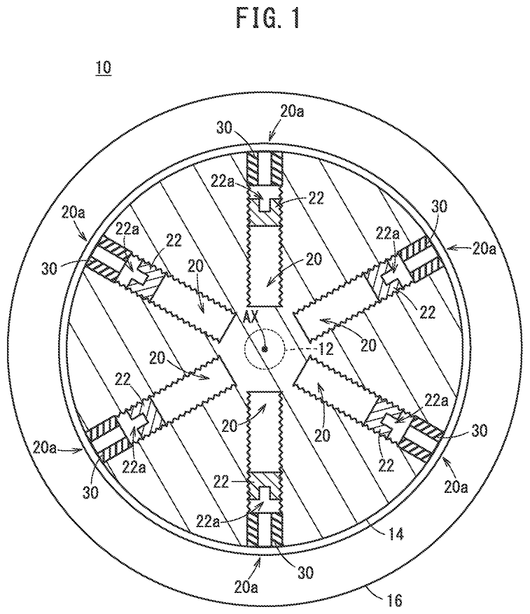

FIG. 1 is a schematic view showing a rotation device 10 of the present embodiment. The rotation device 10 includes a rotatable shaft 12, a rotating body 14 that rotates in conjunction with the shaft 12, and a housing 16 that covers at least part of the shaft 12. FIG. 1 shows a cross section of the rotating body 14 in a direction orthogonal to the shaft 12 for the sake of convenience.

The shaft 12 is rotatably supported by a bearing provided in the housing 16. The shaft 12 is rotated by power transmitted from a motor. The rotating body 14 may be fixed to the shaft 12 or may be fixed to the outer ring of a bearing, as long as the rotating body 14 rotates in conjunction with the shaft 12. Further, the rotating body 14 may be a base member to which a workpiece or a machining tool in a machine tool is attached. The rotating body 14 is provided with a screw hole 20 and a screw 22. The screw hole 20 and the screw 22 are an adjustment mechanism for adjusting the balance of the rotating body 14.

A plurality of the screw holes 20 are provided. The plurality of screw holes 20 are radially arranged with reference to the central axis AX of the rotating body 14. When the rotating body 14 is viewed from one end of the shaft 12, the plurality of screw holes 20 are preferably disposed symmetrically with respect to the central axis AX of the rotating body 14. Each of the plurality of screw holes 20 extends along the radial direction of the rotating body 14, and has an opening 20a that opens on a surface (side surface) of the rotating body 14. FIG. 1 shows an example in which the outer diameters of the screw holes 20 are the same. However, the outer diameters of the screw holes 20 may be different from each other. Alternatively, the screw holes 20 may be paired with the same outer diameter and the outer diameter of one pair of the screw holes 20 may differ from the outer diameter of another pair.

The screw 22 is a balance weight that is screw-engaged with the screw hole 20. The screw 22 is disposed inside one screw hole 20. FIG. 1 shows an example in which a screw 22 is disposed in each of the plurality of screw holes 20. It is noted that there may be a screw hole 20 in which the screw 22 is not disposed. Further, the weight of the screw 22 disposed in each of the two or more screw holes 20 may be the same or different. The screw 22 includes a tool groove 22a formed at an end thereof.

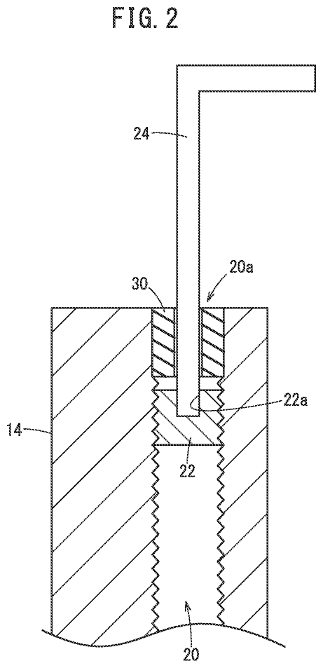

As shown in FIG. 2, the tool groove 22a is a groove into which a tool 24 for turning the screw 22 is fitted. The tool 24 has a shank that can be inserted into the screw hole 20 through the opening 20a of the screw hole 20. The tip of the shank is fitted into the tool groove 22a. The tool 24 may be provided with a handle or the like. Examples of the tool 24 include a bar wrench and a screwdriver.

When the screw 22 disposed inside the screw hole 20 is rotated using the tool 24, the relative position of the screw 22 with respect to the central axis AX of the rotating body 14 changes in the radial direction of the rotating body 14. Therefore, the balance of the centrifugal force generated during rotation of the rotating body 14 changes. Therefore, the balance of the rotating body 14 can be adjusted by adjusting the position of the screw 22 inside the selected screw hole 20 among the plurality of screw holes 20.

The rotation device 10 of the present embodiment is provided with a stopper portion 30. The stopper portion 30 prevents the screw 22 disposed inside the screw hole 20 from coming out from the opening 20a to outside, without hampering the insertion of the tool 24 into the screw hole 20.

In the present embodiment, the stopper portion 30 is a bush (tubular member) having a through hole that is smaller than the inner diameter of the screw hole 20 but is large enough for insertion of the tool 24. The bush is press-fitted from the opening 20a of the screw hole 20 with the screw 22 being disposed therein, whereby the bush is fixed to an end portion of the screw hole 20 that is close to the opening 20a. Owing thereto, even when loosening of the screw 22 screwed into the screw hole 20 occurs due to expansion or the like of the screw hole 20 caused by a temperature change, the screw 22 can be prevented from flying out of the screw hole 20 to the outside during the rotation of the rotating body 14. Further, the tool 24 can be guided to the tool groove 22a of the screw 22 by the bush.

### [Modifications]

The stopper portion 30 can be modified as follows, instead of the bush.

### (First Modification)

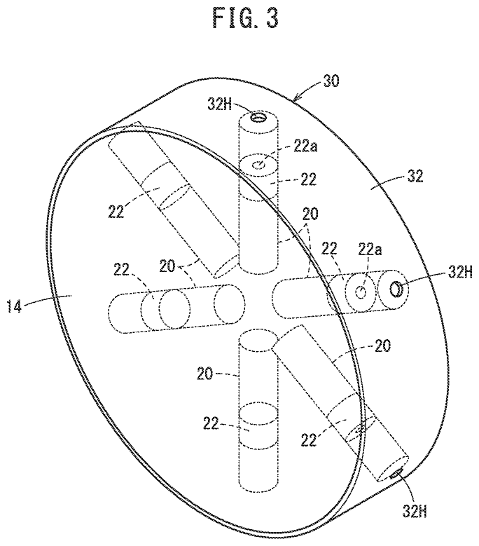

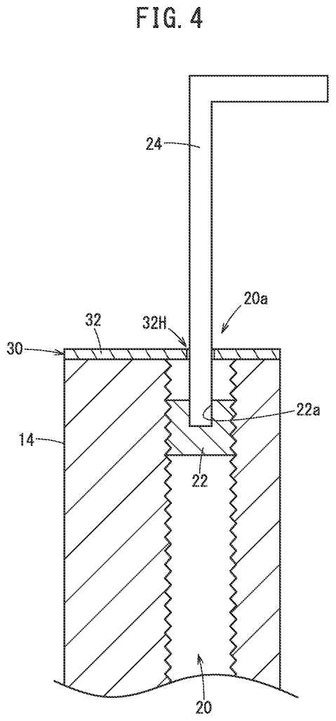

FIG. 3 is a schematic view illustrating the rotating body 14 provided with a stopper portion 30, according to a first modification. FIG. 4 is a schematic view showing the stopper portion 30 of the first modification from the same point of sight as FIG. 2. In FIGS. 3 and 4, the same components as those described in the above embodiment are denoted by the same reference numerals. In the present modification, description concerning portions overlapping with the above embodiment will be omitted.

The stopper portion 30 of the present modification has a structure including a surrounding body 32 that surrounds a radial outer circumferential surface of the rotating body 14, and a plurality of through holes 32H that are formed in the surrounding body 32.

The surrounding body 32 is fixed to the rotating body 14 in a state of being contact with the radial outer circumferential surface of the rotating body 14. The plurality of through holes 32H correspond to the plurality of screw holes 20 on a one-on-one basis. Each through hole 32H is smaller than the inner diameter of the screw hole 20, but large enough for insertion of a tool 24. Each through hole 32H communicates with the screw hole 20 along the radial direction of the rotating body 14.

According to the stopper portion 30 of this modification as well, as in the above-described embodiment, even when loosening of the screw 22 screwed into the screw hole 20 occurs, it is possible to prevent the screw 22 from flying out from the screw hole 20 to the outside during rotation of the rotating body 14. Further, the tool 24 can be guided to the tool groove 22a of the screw 22 by the surrounding body 32.

### (Second Modification)

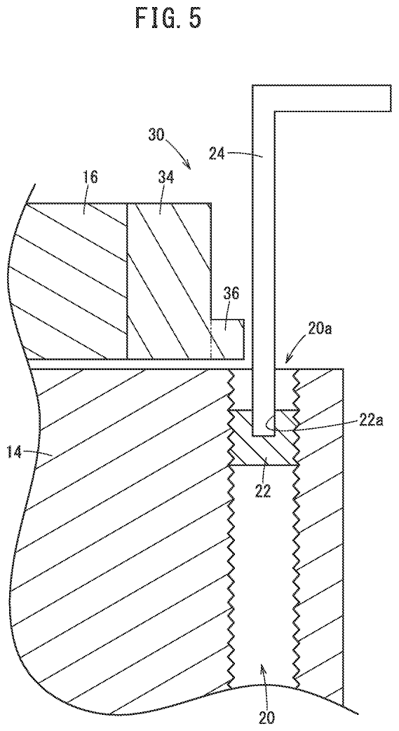

FIG. 5 is a schematic view showing a stopper portion 30 of a second modification from the same viewpoint as in FIG. 2. In FIG. 5, the same components as those described in the above embodiment are denoted by the same reference numerals. In the present modification, description concerning portions overlapping with the above embodiment will be omitted.

The stopper portion 30 of the present modification is fixed to the housing 16. The housing 16 covers the shaft 12 and part of the rotating body 14 that is provided on one end side of the shaft 12. The housing 16 covers a portion of the radial outer circumferential surface of the rotating body 14 that lies on the shaft 12 side, with a gap between the housing 16 and the radial outer circumferential surface. Alternatively, the housing 16 may only cover the shaft 12 but not cover the rotating body 14.

The stopper portion 30 is disposed with a gap between the stopper portion 30 and the radial outer circumferential surface of the rotating body 14. The stopper portion 30 has a support body 34 and a projection 36. The support body 34 is formed into an annular shape and extends from the housing 16 along the axial direction. The projection 36 extends in a direction opposite to a direction from the support body 34 toward the housing 16, and projects to the upper side of a portion of the opening 20a.

The number of the projections 36 may be one or more. When there is only one projection 36, the projection 36 is formed into an annular shape. When there are a plurality of the projections 36, the projections 36 are formed into, for example, a plate shape. The plurality of projections 36 may correspond to the plurality of screw holes 20 on a one-on-one basis.

According to the stopper portion 30 of this modification as well, as in the above-described embodiment, even when loosening of the screw 22 screwed into the screw hole 20 occurs, it is possible to prevent the screw 22 from flying out from the screw hole 20 to the outside during rotation of the rotating body 14.

### (Third Modification)

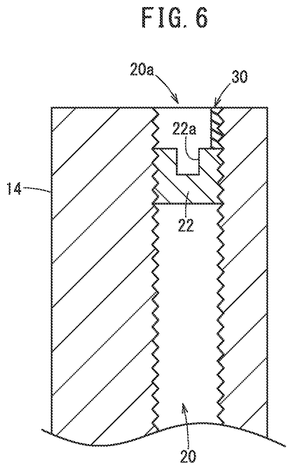

FIG. 6 is a schematic view showing a stopper portion 30 of a third modification from the same viewpoint as in FIG. 2. In FIG. 6, the same components as those described in the above embodiment are denoted by the same reference numerals. In the present modification, description concerning portions overlapping with the above embodiment will be omitted.

The stopper portion 30 of the present modification is a member that covers at least part of the thread groove of an end portion of the screw hole 20 that is close to the opening 20a. Examples of such a member include an adhesive and an adhesive tape. The adhesive may be in an uncured or unhardened state, but is preferably in a cured or hardened state.

According to the stopper portion 30 of this modification as well, as in the above-described embodiment, even when loosening of the screw 22 screwed into the screw hole 20 occurs, it is possible to prevent the screw 22 from flying out from the screw hole 20 to the outside during rotation of the rotating body 14. In addition, in the case of this modification, it is easy to install the stopper portion 30 onto the rotating body 14.

### (Fourth Modification)

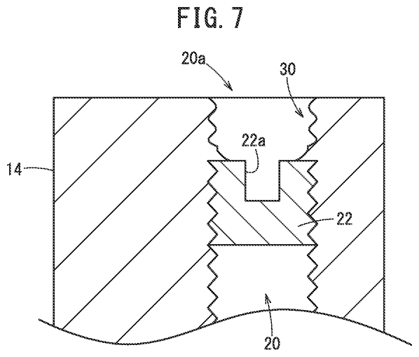

FIG. 7 is a schematic view showing the stopper portion 30 of the fourth modification from the same viewpoint as in FIG. 2. In FIG. 7, the same components as those described in the above embodiment are denoted by the same reference numerals. In the present modification, description concerning portions overlapping with the above embodiment will be omitted.

The stopper portion 30 of the present modification is formed by stripping or damaging at least part of the screw thread of an end portion of the screw hole 20 that is close to the opening 20a. In this case as well, as in the above-described embodiment, even when loosening of the screw 22 screwed into the screw hole 20 occurs, the screw 22 can be prevented from flying out from the screw hole 20 to the outside during the rotation of the rotating body 14. In addition, in the case of this modification, it is easy to install the stopper portion 30 onto the rotating body 14.

### [Invention]

The inventions that can be grasped from the above embodiment and modifications are described below.

The present invention resides in the rotation device (10) equipped with a rotating body (14) which rotates in conjunction with a rotatable shaft (12) and whose balance can be adjusted by using a screw (22). The rotation device (10) includes a plurality of screw holes (20) extending in a radial direction of the rotating body (14) and having an opening (20a) on a surface of the rotating body (14); and a stopper portion (30) configured to prevent the screw (22) disposed inside the screw hole (20) from coming out of the opening (20a) to outside without hampering insertion of a tool (24) configured to turn the screw (22), into the screw hole (20).

Thus, even when loosening of the screw (22) engaged with the screw hole (20) occurs, the screw (22) is prevented from coming out of the screw hole (20) to outside during rotation of the rotating body (14). Therefore, safety can be improved.

The stopper portion (30) may be a bush that is fixed to an end portion of the screw hole (20) that is closed to the opening (20a), the bush having a through hole that is smaller than the screw hole (20) but large enough for insertion of the tool (24). Thus, the screw (22) can be prevented from flying out of the screw hole (20). In addition, a tool (24) can be guided into the tool groove (22a) of the screw (22) by the bush. The bush may be fixed to an end portion of the screw hole (20) that is close to the opening (20a), by press-fitting, shrink-fitting, or bonding, so as not to be detached by centrifugal force during rotation.

The stopper portion (30) may include: a surrounding body (32) that surrounds a radial outer circumferential surface of the rotating body (14); and a through hole (32H) that is formed in the surrounding body (32) and communicates with the screw hole (20) along the radial direction of the rotating body (14), the through hole (32H) being smaller than the screw hole (20) but large enough for insertion of the tool (24). Thus, the screw (22) can be prevented from flying out of the screw hole (20). In addition, a tool (24) can be guided in the tool groove (22a) of the screw (22) by the surrounding body (32).

The stopper portion (30) may be fixed to a housing (16) configured to cover the shaft (12), and may include a projection (36) that projects to an upper side of part of the opening (20a) with a gap between the projection (36) and a radial outer circumferential surface of the rotating body (14). Thus, the screw (22) can be prevented from flying out of the screw hole (20).

The stopper portion (30) may cover at least part of a thread groove of an end portion of the screw hole (20) that is close to the opening (20a). Thus, the screw (22) can be prevented from flying out of the screw hole (20). In addition, it is possible to reduce the size, compared to a case where the stopper portion is provided on the surface side of the rotating body (14).

The stopper portion (30) may be an adhesive. Thus, the screw (22) can be prevented from flying out of the screw hole (20). In addition, it is easy to install the stopper portion (30) to the rotating body (14).

The stopper portion (30) may be formed by damaging at least part of a screw thread of an end portion of the screw hole (20) that is close to the opening (20a). Thus, the screw (22) can be prevented from flying out of the screw hole (20). In addition, it is easy to provide the stopper portion (30) to the rotating body (14).

1. A rotation device equipped with a rotating body that rotates in conjunction with a rotatable shaft and whose balance is adjustable using a screw, comprising:
a plurality of screw holes extending in a radial direction of the rotating body and each having an opening on a surface of the rotating body; and
a stopper portion configured to prevent the screw disposed inside the screw hole from coming out of the opening to outside without hampering insertion of a tool configured to turn the screw, into the screw hole.

2. The rotation device according to claim 1, wherein
the stopper portion is a bush that is fixed to an end portion of the screw hole that is close to the opening, the bush having a through hole that is smaller than the screw hole but large enough for insertion of the tool.

3. The rotation device according to claim 1, wherein
the stopper portion includes: a surrounding body that surrounds a radial outer circumferential surface of the rotating body; and a through hole that is formed in the surrounding body and communicates with the screw hole along the radial direction of the rotating body, the through hole being smaller than the screw hole but large enough for insertion of the tool.

4. The rotation device according to claim 1, wherein
the stopper portion is fixed to a housing configured to cover the shaft, and includes a projection that projects to an upper side of part of the opening with a gap between the projection and a radial outer circumferential surface of the rotating body.

5. The rotation device according to claim 1, wherein
the stopper portion covers at least part of a thread groove of an end portion of the screw hole that is close to the opening.

6. The rotation device according to claim 5, wherein
the stopper portion is an adhesive.

7. The rotation device according to claim 1, wherein
the stopper portion is formed by damaging at least part of a screw thread of an end portion of the screw hole that is close to the opening.
